(19) United States
(12) Patent Application Publication
(10) Pub. No.: US 2011/0099115 A1
(43) Pub. Date: Apr. 28, 2011

(54) SYSTEM AND METHOD OF AUTOMATED APPRAISAL

(75) Inventors: Serge RIVEST, Mississauga (CA); Michael KING, Aurora (CA); Richard CLARK, Markham (CA)

(73) Assignee: DAVIS + HENDERSON, LIMITED PARTNERSHIP, Toronto (CA)

(21) Appl. No.: 12/909,761

(22) Filed: Oct. 21, 2010

(30) Foreign Application Priority Data
Oct. 22, 2009 (CA) 2683992

(51) Int. Cl. G06Q 99/00; G06Q 90/00

(52) U.S. Cl. 705/306; 705/500

(57) ABSTRACT

The invention consists of a method of automating appraisals requested by a requesting party, comprising: a) providing an appraisal form via a remotely accessible interface for completion by an appraiser; b) reviewing the completed appraisal form for validity and identifying any errors; c) analyzing the validated form according to a series of rules and indicating items of interest according to said rules; and d) forwarding the appraisal to the requesting party.

### Field of the Invention

The present invention relates to the field of real estate appraisals. In particular, it relates to a system and method of requesting and creating appraisals.

### BACKGROUND OF THE INVENTION

When a lending institution, such as a bank, is granting a mortgage or a loan using real estate as equity, the key element in determining the amount of loan for which the applicant will qualify is the value of the real estate in question. In order to assess this value, an appraisal is required. The appraisal is performed by a skilled professional who is trained to assess the relevant data and reach a conclusion based on a combination of objective and subjective factors.

For large institutions, which deal with a number of transactions on a daily basis, rather than contact appraisers directly, the appraisal requests are sent to an agent. The agent is responsible for contacting appraisers, typically from a pre-determined list of appraisers based on geographic region, receiving the appraisals, and forwarded the results to the institution.

While advances in technology have made parts of the process easier (e.g. requests can be sent by facsimile or email, as can results), there is still substantial room for improvement. One such area of improvement is in the turn-around time associated with contacting the appraiser and receiving the appraisal. Given that a full real estate appraisal requires the professional combination of objective and subjective factors, and this requires a certain amount of time, any reduction in the time required for the transactional steps of the process is of benefit.

Another aspect arises from the development of streamlined or automated appraisal systems. These appraisal systems have arisen as an alternative to the time and cost required to obtain a full professional appraisal. They use data on other properties of a similar type in the same or a similar area to derive an appraisal, which is generally less accurate than a full appraisal, but is sufficient for smaller, low-risk matters where the approximate appraisal valuation is all that is required. There is a need for an appraisal request system that is capable of determining the scope of appraisal warranted for any particular matter, and assigning the appraisal to a suitable workflow category as a result.

It is an object of this invention to partially or completely fulfill one or more of the above-mentioned needs.

### SUMMARY OF THE INVENTION

The invention consists of a method of automating appraisals requested by a requesting party, such as a lending institution, comprising: a) providing an appraisal form via a remotely accessible interface for completion by an appraiser; b) reviewing the completed appraisal form for validity and identifying any errors; c) analyzing the validated form according to a series of rules and indicating items of interest according to said rules; and d) forwarding the appraisal to the requesting party.

The method may further include an additional selecting step to determine the type of appraisal requested.

Preferably, the requesting party can customize the form and the analysis rules to meet its needs.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a flow chart showing a preferred method of the present invention; and

FIG. 2 is a flow chart showing a method of appraisal type selection according to the present invention.

### DETAILED DESCRIPTION OF THE PREFERRED EMBODIMENTS

The inventive system and method presented herein consists of a process for requesting and receiving real estate appraisals, as well as a system for collecting the appraisal data from the appraisers.

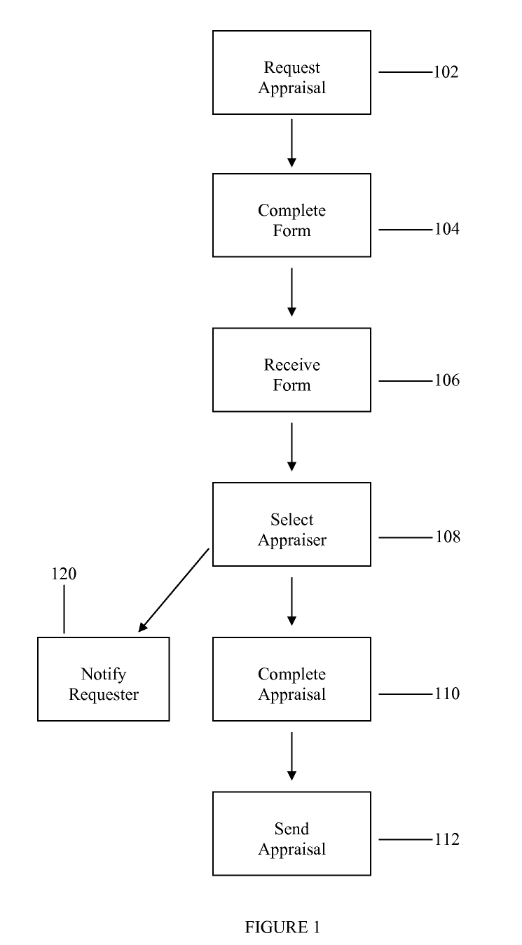

Following the flowchart shown in FIG. 1, first, a request for appraisal is sent out (step 102) by the lender, usually a bank or similar institution. Typically, this request will arise from the property in question being used as collateral for a mortgage or a loan. The information in the request is a combination of basic identification information: address/location of property, name of owner, etc. and any additional information deemed useful by the requesting party, including any particular details that may make the specific request deviate from the standard form of request. The required information is input by the requesting party into a digital form (step 104), preferably a web-based form.

The request is received (step 106) by the appraisal system and a suitable appraiser is contacted (step 108), based on the geographic location of the real estate being appraised. Ideally, the appraiser contact is made via telephone or email to get the most rapid response. A list of appraisers is maintained, and where time is of the essence, a response priority list is used. In that case, if the contacted appraiser fails to respond within a pre-determined minimum time (e.g. five minutes), the next appraiser on the list is contacted, and so forth until an appraiser responds.

Once the appraiser responds and accepts the task of making the appraisal, the digital form is forwarded to the appraiser for completion (step 110). Additionally, the requesting party can be notified (step 120) that the appraisal is taking place and given a time estimate for the appraisal (as provided by the appraiser).

As the appraisal form is digital, it can be modified and customized by the requesting party to meets its need with respect to appraisals and appraisers. If additional non-standard information is required, or if the information needs to be in a specific format, than the form can be modified accordingly. Furthermore, the digital form can be self-checking and self-correcting, ensuring that the information input meets the requirements of the form, and thus allowing the appraisal to be processed more rapidly and efficiently.

Some of the modifications to the form can include flags for high-risk loans, the ability to annotate specific fields, and business-specific fields, such as file codes. The flags can be activated by the appraiser, automatically activated by the form when completed, or both. As the form is fully digital, it can be quickly analyzed after completion to detect any unusual entries, such as a professional adjustment that exceeds a certain amount, or other entries by the appraiser that, while correctly entered, should be flagged for review by the requesting party once the appraisal is received.

Once the appraisal is completed, it is sent (step 112) to the requesting party, with any annotations and/or flags that may have arisen during the appraisal process.

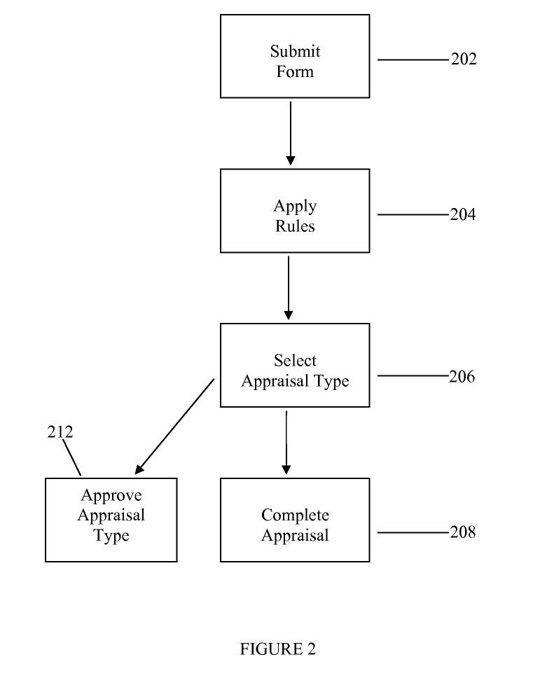

One potential application for the system is its use in combination with an automated valuation appraisal network as shown in the flowchart in FIG. 2. An automated valuation is primarily of application in urban areas, where housing is dense and sales are common. The address of the property to be valued is taken and past sales in the area are use to create a valuation. The size and shape of the area is defined based on available data on similarity of buildings, sales figures, and other factors. The resulting valuation is less thorough than a full appraisal, but the result is available much more quickly, making it suitable for low-risk loans where the approximation produced by automated valuation can be sufficient to mitigate the risk.

As a next stage in the automated valuation process, the loan can be insured by a third party against default based on the valuation. In this way, if the valuation proves to be too generous, the lender can remain protected for the balance.

A still further stage would be to incorporate a brief verification by an appraiser, typically as a drive-by of the property to confirm its location and existence, as well as its general condition.

Finally, there is a full appraisal as conducted by a licensed and authorized appraiser. The full appraisal would preferably follow the same procedures as set out above. If desired, the rules could be applied at a more granular level to the full appraisal, identifying areas of focus or limitations in scope to expedite the response from the appraiser.

When multiple appraisal options are available, once the appraisal request form is submitted (step 202), the system applies a set of rules (step 204), preferably as provided by the lender, to determine which type of appraisal is required for any particular loan. The result is a selected (step 206) hierarchy of appraisal types, from quick-response, low-accuracy to slow-response, high-accuracy, with variations in between. The rules can be simple, such as a mere indication on the form of which type of appraisal is requested. Once the type of appraisal is determined, it may be confirmed with the requesting party (step 212), who can approve or change it. The form is then processed or sent out as required to complete the appraisal (step 208).

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A method of automating appraisals requested by a requesting party, comprising:
a) providing a customizable, digital appraisal form for completion by an appraiser;
b) reviewing the completed appraisal form for validity and identifying any errors in the form for correction;
c) analyzing the validated appraisal form according to a series of rules and indicating items of interest on said form according to said rules; and
d) forwarding the completed, validated appraisal form to the requesting party.

2. The method of claim 1, wherein said appraisal form is provided via a remotely accessible interface.

3. The method of claim 1, wherein said rules are supplied by the requesting party.

4. The method of claim 1, wherein said form is customizable by said requesting party.

5. The method of claim 1, further including a selecting step for selecting an appraisal type for use from a set of pre-determined appraisal types.

6. The method of claim 5, wherein said set of pre-determined appraisal types includes one or more of: a full appraisal, an automated valuation appraisal, and an insured automated valuation appraisal.

7. The method of claim 6, wherein said selecting step is performed as part of requesting said appraisal.

8. The method of claim 6, wherein said selecting step is performed after said appraisal is requested.

9. A method of selecting an appraisal type, comprising:
a) reviewing information about a property to be appraised;
b) analyzing said information according to a series of rules; and
c) selecting an appraisal type based on said rules.

10. The method of claim 9, wherein said rules are provided by a party requesting an appraisal.

11. The method of claim 9, wherein said appraisal type is one of: an automated valuation, an insured automated valuation, a verified automated valuation, and a full appraisal.

12. The method of claim 9, including a further step of receiving confirmation of the appraisal type from the requesting party.
